(19) United States
(12) Patent Application Publication
(10) Pub. No.: US 2026/0242186 A1
(43) Pub. Date: Aug. 20, 2026

(54) CRANE

(71) Applicant: TADANO LTD., Kagawa (JP)

(72) Inventors: Takashi KAWANO, Kagawa (JP); Kimihiko TERATA, Kagawa (JP); Shota NAKAMATSU, Kagawa (JP)

(73) Assignee: TADANO LTD., Kagawa (JP)

(21) Appl. No.: 18/872,292

(22) PCT Filed: Jun. 15, 2023
(86) PCT No.: PCT/JP2023/022320

§ 371 Date: Dec. 6, 2024

(30) Foreign Application Priority Data
Jun. 24, 2022 (JP) 2022-102122

(51) Int. Cl. B66C 23/00; B66C 13/52; B66C 23/38; B66C 23/86; F15B 1/26; F15B 15/18

(52) U.S. Cl. CPC B66C 23/54; B66C 13/52; B66C 23/38; B66C 23/86; F15B 1/26; F15B 15/18; B66C 2700/0371

(57) ABSTRACT

This crane includes: a traveling vehicle body that travels on the basis of power supplied from a power source; a hydraulic oil tank that is provided to the traveling vehicle body; and a hydraulic oil supply device that includes a motor which is driven by the power source, and a pump part which is driven by the motor and which supplies the hydraulic oil, supplied from the hydraulic oil tank, to a driven part. The pump part is disposed below the liquid level of the hydraulic oil inside the hydraulic oil tank.

### TECHNICAL FIELD

The present invention relates to a crane.

### BACKGROUND ART

Patent Literature 1 discloses a mobile crane including a lower traveling body having a traveling function and an upper swing body provided in a swingable state on an upper portion of the lower traveling body. The lower traveling body includes an engine and travels on the basis of power of the engine.

### CITATION LIST

### Patent Literature

Patent Literature 1: JP 2012-96928 A

### SUMMARY OF THE INVENTION

### Problems to be Solved by the Invention

In recent years, there has been a demand for motorized cranes as described above from the viewpoint of environmental protection and the like.

An object of the present invention is to provide a crane that can travel by electric power.

### Solutions to Problems

An aspect of a crane according to the present invention includes a traveling vehicle body that travels on the basis of power supplied from a power source, a hydraulic oil tank provided in the traveling vehicle body, and a hydraulic oil supply device including a motor driven by the power source and a pump part driven by the motor and supplying hydraulic oil to a driven part, the hydraulic oil being supplied from the hydraulic oil tank, wherein the pump part is disposed below a liquid level of hydraulic oil in the hydraulic oil tank.

### Effects of the Invention

According to the present invention, it is possible to provide a crane that can travel by electric power.

### BRIEF DESCRIPTION OF DRAWINGS

FIG. 1 is a schematic view of a mobile crane according to the first embodiment.

FIG. 2 is a block diagram schematically illustrating a system configuration of a mobile crane.

FIG. 3 is a perspective view of a crane from which part of the configuration is omitted.

FIG. 4 is a diagram for describing the arrangement of a transmission member, a tank, and a hydraulic oil supply device.

FIG. 5 is a schematic view illustrating a tank and a hydraulic oil supply device when viewed from the side.

FIG. 6 is a diagram for describing a configuration of a transmission member, a tank, and a hydraulic oil supply device according to the second embodiment.

FIG. 7 is a diagram for describing a configuration of a transmission member, a tank, and a hydraulic oil supply device according to the second embodiment.

FIG. 8 is a diagram for describing an arrangement of a transmission member, a tank, and a hydraulic oil supply device according to the third embodiment.

FIG. 9 is a diagram for describing an arrangement of a transmission member, a tank, and a hydraulic oil supply device according to the third embodiment.

FIG. 10 is a diagram for describing the arrangement of a transmission member, a tank, and a hydraulic oil supply device according to the fourth embodiment.

FIG. 11 is a diagram for describing the arrangement of a transmission member, a tank, and a hydraulic oil supply device according to the fourth embodiment.

FIG. 12 is a diagram for describing the arrangement of a transmission member, a tank, and a hydraulic oil supply device according to the fifth embodiment.

FIG. 13 is a diagram for describing the arrangement of a transmission member, a tank, and a hydraulic oil supply device according to the fifth embodiment.

FIG. 14 is a diagram for describing the arrangement of a transmission member, a tank, and a hydraulic oil supply device according to the sixth embodiment.

FIG. 15 is a diagram for describing the arrangement of a transmission member, a tank, and a hydraulic oil supply device according to the sixth embodiment.

### DESCRIPTION OF EMBODIMENTS

Hereinafter, an example of embodiments of the crane according to the present invention will be described in detail on the basis of the drawings. Note that a crane according to the embodiments described below is an example of a crane according to the present invention, and the present invention is not limited to the embodiments described below.

### First Embodiment

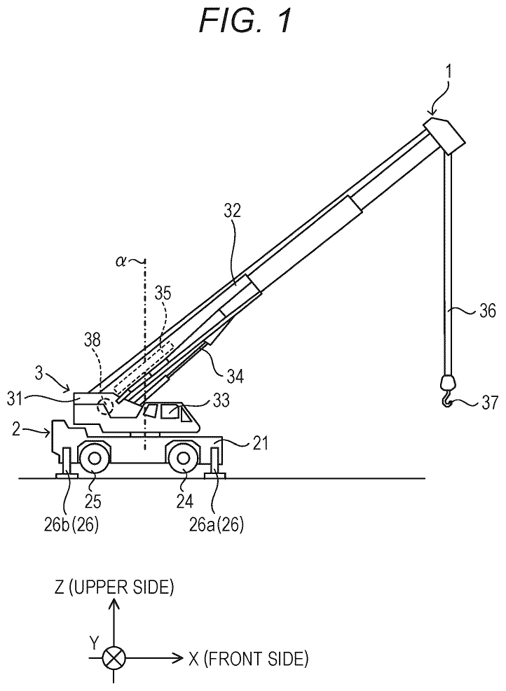

FIG. 1 is a schematic view of a mobile crane 1 (in the illustrated case, a rough terrain crane) according to the present embodiment. The mobile crane is, for example, an all-terrain crane, a truck crane, or a loading type truck crane (It is also referred to as a cargo crane). However, the crane according to the present invention may be various cranes.

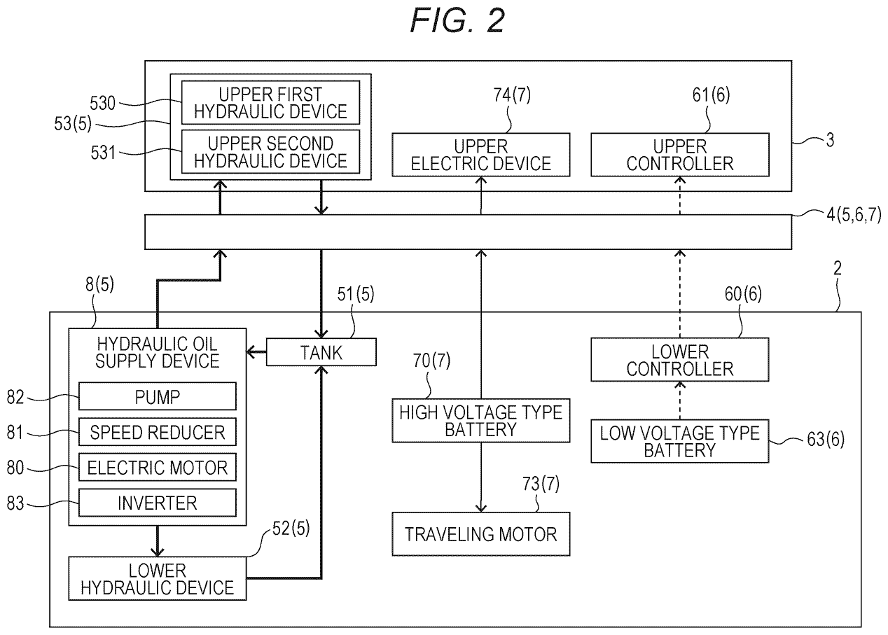

The mobile crane 1 includes a lower traveling body 2 and an upper swing body 3. The mobile crane 1 is an electric crane including a high voltage type battery 70 (see FIG. 2). The mobile crane 1 travels on the basis of power supplied from the high voltage type battery 70. That is, the mobile crane 1 does not include an engine.

In addition, the mobile crane 1 executes operations (for example, crane work, cooling, and/or heating) other than traveling on the basis of the power supplied from the high voltage type battery 70. The crane work is, for example, a swing operation and/or a winch operation in a cargo conveyance operation. Hereinafter, a specific configuration of the mobile crane 1 will be described.

First, the configuration of the upper swing body 3 will be described with reference to FIG. 1. FIG. 1 is a schematic diagram of a mobile crane 1. The upper swing body 3 is provided on the upper portion of the lower traveling body 2, and can turn about a turning center axis a with respect to the lower traveling body 2. The upper swing body 3 includes a turning table 31, a telescopic boom 32, and a cab 33.

The turning table 31 is supported 3 on the upper portion of the lower traveling body 2 via a bearing (not illustrated). The turning table 31 turns on the basis of power generated by a turning actuator (not illustrated) provided in the upper swing body 3. In the present embodiment, the turning actuator is a hydraulic motor. The motor operates on the basis of supply and discharge of hydraulic oil. The hydraulic oil is supplied from the lower traveling body 2. The turning actuator may be an electric motor. In this case, the turning electric motor is driven on the basis of power supplied from a high voltage type battery 70 described later.

The telescopic boom 32 is supported by the turning table 31 and has a plurality of telescopically combined booms. The telescopic boom 32 can change the derricking angle on the basis of the power generated by a derricking cylinder 34 (derricking).

The derricking cylinder 34 is a telescopic hydraulic cylinder and is provided in the upper swing body 3. The derricking cylinder 34 operates on the basis of supply and discharge of hydraulic oil. The hydraulic oil is supplied by a hydraulic oil supply device 8 provided in the lower traveling body 2.

The telescopic boom 32 expands and contracts on the basis of power generated by a telescopic cylinder 35. The telescopic cylinder 35 is a hydraulic cylinder and is provided inside the telescopic boom 32. The telescopic cylinder 35 operates on the basis of supply and discharge of hydraulic oil. The hydraulic oil is supplied by a hydraulic oil supply device 8 provided in the lower traveling body 2.

The telescopic boom 32 supports a wire rope 36. The wire rope 36 hangs down from a distal end of the telescopic boom 32, and a hook 37 is provided at the distal end. Part of the wire rope 36 is wound around a winch 38.

The winch 38 is driven (rotates) on the basis of power generated by a winch actuator (not illustrated). In the present embodiment, the winch actuator is provided on the turning table 31 and is a hydraulic motor. The motor operates on the basis of supply and discharge of hydraulic oil. The hydraulic oil is supplied by a hydraulic oil supply device 8 provided in the lower traveling body 2.

When the winch 38 rotates, the wire rope 36 is wound up or unwound according to the rotation direction of the winch 38. The winch motor may be an electric motor. In this case, the winch electric motor is driven on the basis of power supplied from a high voltage type battery 70 described later.

Next, the lower traveling body 2 will be described with reference to FIGS. 1 to 5. In describing the structure of the lower traveling body 2, an orthogonal coordinate system (X, Y, Z) illustrated in each drawing is used. The X direction corresponds to the front-rear direction of the lower traveling body 2. The X direction +side corresponds to the front side of the lower traveling body 2. The X direction −side corresponds to the rear side of the lower traveling body 2. The Y direction corresponds to the left-right direction of the lower traveling body 2. The Y direction +side corresponds to the left side when the lower traveling body 2 is viewed from the rear. The Y direction −side corresponds to the right side when the lower traveling body 2 is viewed from the rear. The Z direction corresponds to the vertical direction of the lower traveling body 2. The Z direction +side corresponds to the upper side of the lower traveling body 2. The Z direction −side corresponds to the lower side of the lower traveling body 2.

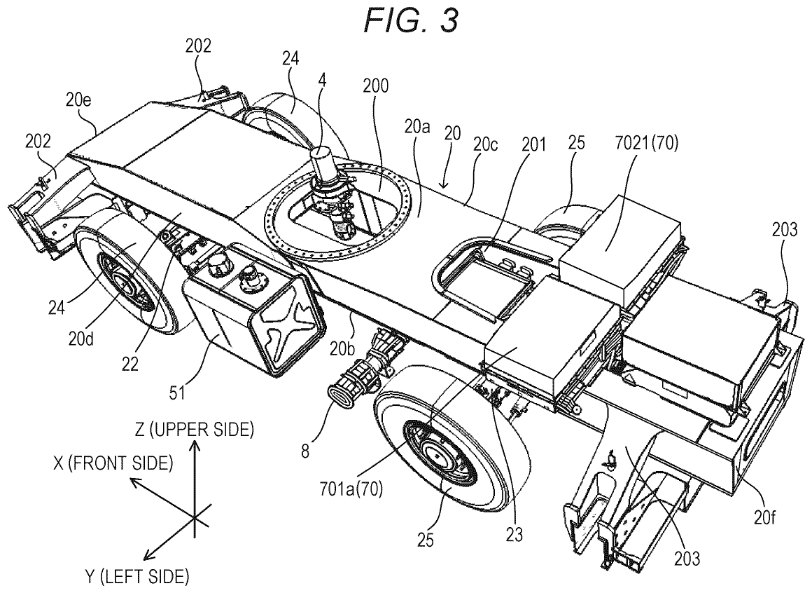

The lower traveling body 2 corresponds to an example of a traveling vehicle body, and can travel by electric power. Specifically, as illustrated in FIGS. 1 and 3, the lower traveling body 2 includes a frame 20, a body 21, a front axle 22, a rear axle 23, front tires 24, rear tires 25, and an outrigger 26.

The frame 20 corresponds to an example of a main frame, extends in the front-rear direction, is, for example, a box-shaped member having a rectangular cross-sectional shape, and constitutes a framework of the lower traveling body 2. The frame 20 includes an upper plate portion 20a, a lower plate portion 20b, a right plate portion 20c, a left plate portion 20d, a front plate portion 20e, and a rear plate portion 20f.

The frame 20 has a transmission member arrangement space 200 configured by a through hole penetrating the frame 20 in the vertical direction. The transmission member arrangement space 200 is provided at a central position between the front axle 22 and the rear axle 23 in the frame 20.

The frame 20 has a battery housing space 201 configured by a through hole penetrating the frame 20 in the vertical direction. The battery housing space 201 is provided at a position extending from the upper side to the rear end of the rear axle 23 in the frame 20. That is, the battery housing space 201 is provided in the rear portion of the frame 20. In the frame 20, transverse cross section of a portion where the battery housing space 201 is formed is a closed cross section configured by a plurality of continuous plate portions. The transverse cross section of the frame 20 means a cross section of the frame 20 cut along the YZ plane.

The position of the battery housing space is not limited to the illustrated case. The battery housing space may be provided at a position extending from the upper side to the front end of the front axle 22 in the frame 20.

Also in this case, the battery housing space may be configured by a through hole penetrating the frame 20 in the vertical direction.

The frame 20 has a pair of front outrigger supports 202 at the front end. The frame 20 has a pair of rear outrigger supports 203 at the rear end.

The body 21 (see FIG. 1) is a member constituting the outer shape of the lower traveling body 2, and is supported by the frame 20.

The front axle 22 is a shaft member extending in the left-right direction, and is supported by a portion of the frame 20 near the front end of the lower plate portion 20b. The front tires 24 are rotatably supported at both ends of the front axle 22 in the left-right direction.

The rear axle 23 is a shaft member extending in the left-right direction, and is supported by a portion of the frame 20 near the rear end of the lower plate portion 20b. The rear tires 25 are rotatably supported at both ends of the rear axle 23 in the left-right direction. In the present embodiment, the mobile crane 1 is a so-called bi-axle mobile crane including the front axle 22 and the rear axle 23. However, the mobile crane may be a so-called multi-axle mobile crane having three or more axles.

The outrigger 26 includes a pair of front outriggers 26a and a pair of rear outriggers 26b. The pair of front outriggers 26a is supported by the pair of front outrigger supports 202 of the frame 20. Further, the pair of rear outriggers 26b is supported by the pair of rear outrigger supports 203 of the frame 20.

The mobile crane 1 includes a transmission member 4 provided between the lower traveling body 2 and the upper swing body 3. Specifically, the transmission member 4 is disposed in the transmission member arrangement space 200 of the frame 20. Such a transmission member 4 is a member for transmitting power, fluid (hydraulic oil and/or compressed air), signals, and the like between the relatively rotating lower traveling body 2 and upper swing body 3.

As illustrated in FIG. 2, the mobile crane 1 includes a low voltage type system 6, a high voltage type system 7, and a hydraulic system 5. Hereinafter, configurations of the low voltage type system 6, the high voltage type system 7, and the hydraulic system 5 will be described.

First, the low voltage type system 6 will be described. The low voltage type system 6 includes a lower controller 60, a transmission member 4, an upper controller 61, and a low voltage type battery 63.

The lower controller 60 transmits, for example, a video signal, a detection signal of a sensor, and a control signal to the upper controller 61 via the transmission member 4. The control signal is a signal for controlling the operation of the device provided in the upper swing body 3 to be controlled. The lower controller 60 operates on the basis of power supplied from the low voltage type battery 63.

The upper controller 61 transmits a signal received from the lower controller 60 to a control device that controls the operation of a device provided in the upper swing body 3. The control device includes, for example, an electromagnetic valve that controls the operation of an upper hydraulic device 53 and a controller that controls the operation of an upper electric device 74.

In addition to the signal, the low voltage type system 6 may transmit, for example, information about the operation of a device provided in the upper swing body 3 and/or a current equal to or less than a predetermined voltage supplied to the device from the lower traveling body 2 to the upper swing body 3.

Next, the high voltage type system 7 will be described. The high voltage type system 7 is a system for executing traveling of the lower traveling body 2 and operations other than traveling (for example, crane work, cooling, and/or heating) on the basis of the power supplied from the high voltage type battery 70.

As illustrated in FIG. 2, the high voltage type system 7 includes a high voltage type battery 70, a traveling motor 73, a transmission member 4, and an upper electric device 74.

The high voltage type battery 70 corresponds to an example of a power source, and includes a plurality of batteries 701a and 701b as illustrated in FIG. 3. The batteries 701a and 701b are disposed outside the frame 20 (specifically, the upper side). Further, the high voltage type battery 70 has a plurality of batteries (not shown) disposed in the battery housing space 201 of the frame 20.

The traveling motor 73 includes, for example, a front traveling motor and a rear traveling motor (not illustrated). The front traveling motor and the rear traveling motor are provided below the frame 20 and between the front axle 22 and the rear axle 23.

The traveling motor 73 as described above is driven on the basis of power supplied from the high voltage type battery 70 under the control of a control unit (not illustrated). When the traveling motor 73 is driven, the lower traveling body 2 (mobile crane 1) can travel on the basis of the power of the traveling motor 73.

The power of the high voltage type battery 70 is transmitted to the upper swing body 3 via the transmission member 4.

The transmission member 4 constitutes an electric path of power supplied from the high voltage type battery 70 to the upper electric device 74 between the relatively rotating lower traveling body 2 and upper swing body 3. The upper electric device 74 is a device that is provided in the upper swing body 3 and operates on the basis of the power of the high voltage type battery 70. The upper electric device 74 is, for example, a heating compressor provided in the upper swing body 3.

When the turning actuator is an electric motor, the turning electric motor corresponds to an example of the upper electric device. When the winch actuator is an electric motor, the winch electric motor corresponds to an example of the upper electric device. In this case, the transmission member 4 is connected to the turning electric motor and the winch electric motor via an upper junction box (not illustrated). Such an upper junction box has a function of allocating the power of the high voltage type battery 70 supplied via the transmission member 4 to the turning electric motor and the winch electric motor.

When power of the high voltage type battery 70 is supplied, the turning electric motor is driven on the basis of the power. The turning electric motor turns the upper swing body 3. In addition, when power of the high voltage type battery 70 is supplied, the winch electric motor is driven on the basis of the power. The winch electric motor rotates the winch (not illustrated). As a result, the wire rope 36 is wound up or unwound, and the hook 37 ascends or descends.

Next, the hydraulic system 5 will be described. The hydraulic system 5 is a system for supplying hydraulic oil to a lower hydraulic device 52 provided in the lower traveling body 2 and an upper hydraulic device 53 provided in the upper swing body 3. The lower hydraulic device 52 includes, for example, a hydraulic cylinder constituting a suspension and/or a hydraulic cylinder constituting an outrigger. In addition, the lower hydraulic device 52 may include a hydraulic cylinder constituting a steering device.

The upper hydraulic device 53 includes the turning actuator (not illustrated), the derricking cylinder 34, the telescopic cylinder 35, and the winch actuator (not illustrated). The upper hydraulic device 53 may include an actuator for moving the jib.

The hydraulic system 5 includes a tank 51, the hydraulic oil supply device 8, and the transmission member 4. The hydraulic system 5 also includes the upper hydraulic device 53 and the lower hydraulic device 52. The elements constituting the hydraulic system 5 are connected by a circuit indicated by a thick line in FIG. 2.

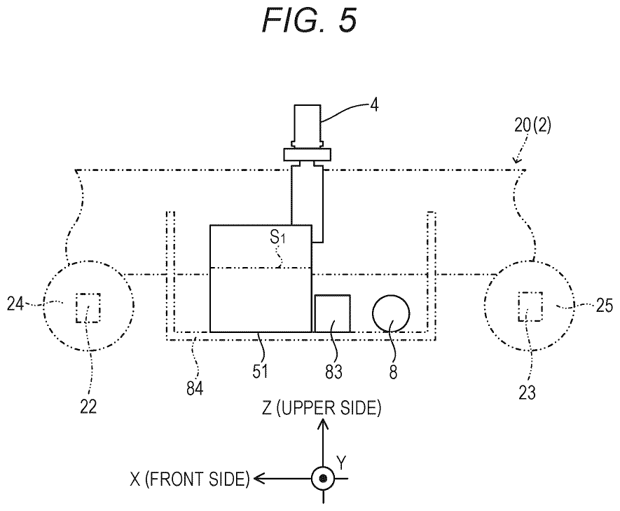

The tank 51 and the hydraulic oil supply device 8 are provided in the lower traveling body 2. Specifically, as illustrated in FIGS. 3 and 5, the tank 51 and the hydraulic oil supply device 8 are disposed in a predetermined region between the front axle 22 and the rear axle 23 and side (left side in the case of the present embodiment) of the frame 20 in the left-right direction.

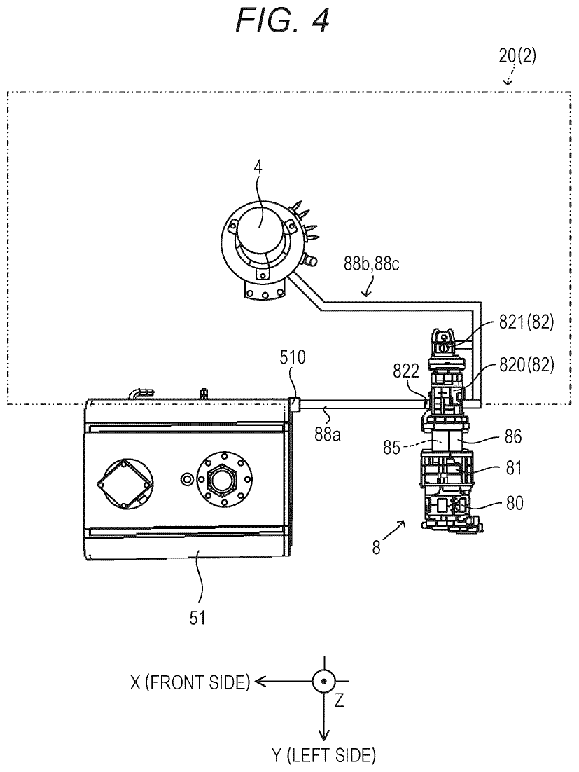

The tank 51 corresponds to an example of a hydraulic oil tank, is a tank for storing hydraulic oil, and has a substantially rectangular parallelepiped box shape. As shown in FIG. 4, the tank 51 is disposed side (left side in the case of the present embodiment) of the transmission member 4. The tank 51 and the hydraulic oil supply device 8 are disposed side by side in the front-rear direction in the predetermined region. The tank 51 is disposed in front of the hydraulic oil supply device 8. The tank 51 and the hydraulic oil supply device 8 are fixed to a side face (left side face in the case of the present embodiment) of the frame 20 via a fixing member 84 (see FIG. 5).

The hydraulic oil supply device 8 is provided side (rear side in the case of the present embodiment) of the tank 51. The hydraulic oil supply device 8 includes an electric motor 80, a speed reducer 81, and a pump 82 in this order from one side (left side in the case of the present embodiment) in the axial direction. The electric motor 80, the speed reducer 81, and the pump 82 are coaxially provided. In other words, the electric motor 80, the speed reducer 81, and the pump 82 are connected in series. The axial direction of the hydraulic oil supply device 8 is a direction parallel to the center axis of the hydraulic oil supply device 8. In the present embodiment, the axial direction of the hydraulic oil supply device 8 is a direction parallel to the left-right direction.

As illustrated in FIG. 5, the speed reducer 81 and the pump 82 are connected via a coupling 85. The coupling 85 is housed in a cylindrical housing 86. A support 87 is fixed to the housing 86. The hydraulic oil supply device 8 is fixed to the fixing member 84 by the support 87.

The electric motor 80 is driven on the basis of power supplied from the high voltage type battery 70 via an inverter 83 (see FIGS. 2 and 5). The inverter 83 is provided between the tank 51 and the hydraulic oil supply device 8 in the front-rear direction. In FIG. 2, a circuit connecting the inverter 83 and the high voltage type battery 70 is omitted.

The speed reducer 81 decelerates the rotation of the electric motor 80 at a predetermined speed reduction ratio to transmit the rotation to the coupling 85. The coupling 85 transmits the rotation transmitted from the speed reducer 81 to the pump 82.

The pump 82 corresponds to an example of a pump part, and operates on the basis of the rotation transmitted from the electric motor 80. The pump 82 includes a first pump 820 and a second pump 821 in order from the pump closer to the speed reducer 81. Each of the first pump 820 and the second pump 821 correspond to an example of a pump in the pump part. The first pump 820 and the second pump 821 are coaxially disposed.

Each of the first pump 820 and the second pump 821 is connected to the tank 51 via a discharge hose 88a (see FIG. 4). The first end of the discharge hose 88a is connected to an outlet-port 510 of the tank 51. The second end of the discharge hose 88a is connected to an inlet-port 822 of the pump 82. The outlet-port 510 of the tank 51 is provided on the rear face of the tank 51.

The hydraulic oil flowing out from the outlet-port 510 of the tank 51 passes through the discharge hose 88a and flows into the pump 82 from the inlet-port 822. The hydraulic oil flowing from the inlet-port 822 flows into each of the first pump 820 and the second pump 821.

The discharge hose 88a extends behind the outlet-port 510 of the tank 51. The discharge hose 88a may be parallel to the front-rear direction or may be inclined with respect to the front-rear direction.

In the present embodiment, since the tank 51 and the hydraulic oil supply device 8 (pump 82) are collectively disposed in a predetermined region, the length of the discharge hose 88a can be shortened. Therefore, the connection structure between the tank 51 and the hydraulic oil supply device 8 (pump 82) can be made compact. Further, since the discharge hose 88a is short, when the discharge hose 88a is damaged, maintenance work of the discharge hose 88a can be efficiently performed.

The first pump 820 is driven on the basis of the rotation of the electric motor 80 to supply hydraulic oil to a first driven part. In the case of the present embodiment, the first driven part is an upper first hydraulic device 530 (see FIG. 2) included in the upper hydraulic device 53. The upper first hydraulic device 530 includes the derricking cylinder 34, the telescopic cylinder 35, and a winch actuator (not illustrated). The upper first hydraulic device 530 may include an actuator for moving the jib. The first driven part includes an outrigger hydraulic cylinder included in the lower hydraulic device 52.

When the hydraulic oil is supplied to the upper first hydraulic device 530, the first pump 820 supplies the hydraulic oil to the transmission member 4. The transmission member 4 constitutes a flow path of a fluid (for example, hydraulic oil and/or compressed air) supplied from the lower traveling body 2 to the upper swing body 3 between the lower traveling body 2 and the upper swing body 3 that relatively rotate. Specifically, the transmission member 4 constitutes part of a flow path for supplying the hydraulic oil supplied from the hydraulic oil supply device 8 (first pump 820) to the upper hydraulic device 53 provided in the upper swing body 3.

The hydraulic oil used in the upper first hydraulic device 530 passes through the transmission member 4 and returns to the tank 51. The transmission member 4 also constitutes part of a flow path of hydraulic oil returning from the upper swing body 3 to the lower traveling body 2. The first pump 820 and the transmission member 4 are connected via a discharge hose 88b (see FIG. 4). In the case of the present embodiment, since the first pump 820 and the transmission member 4 are collectively disposed in the predetermined region, the length of the discharge hose 88b can be shortened. Therefore, the connection structure between the first pump 820 and the transmission member 4 can be made compact. Further, since the discharge hose 88b is short, the maintenance work of the discharge hose 88b can be efficiently performed when the discharge hose 88b is damaged.

When the winch actuator (not illustrated), the derricking cylinder 34, and the telescopic cylinder 35 are provided in mutually independent hydraulic circuits, the first pump 820 may be configured by a plurality of independent pumps corresponding to the respective hydraulic circuits.

The second pump 821 is driven on the basis of the rotation of the electric motor 80 to supply the hydraulic oil to a second driven part. In the case of the present embodiment, the second driven part is the upper second hydraulic device 531 (see FIG. 2) included in the upper hydraulic device 53. The upper second hydraulic device 531 includes a turning actuator (not illustrated) and a hydraulic cylinder constituting a steering device.

When the hydraulic oil is supplied to an upper second hydraulic device 531, the second pump 821 supplies the hydraulic oil to the transmission member 4. The transmission member 4 constitutes part of a flow path for supplying the hydraulic oil supplied from the hydraulic oil supply device 8 (second pump 821) to the upper second hydraulic device 531 provided in the upper swing body 3.

The hydraulic oil used in the upper second hydraulic device 531 passes through the transmission member 4 and returns to the tank 51. The transmission member 4 also constitutes a flow path for the hydraulic oil returning from the upper swing body 3 to the lower traveling body 2.

The second pump 821 and the transmission member 4 are connected via a discharge hose 88c (see FIG. 4). In FIG. 4, the discharge hose 88b and the discharge hose 88c are illustrated as one discharge hose for the sake of convenience, but the discharge hose 88b and the discharge hose 88c are independent from each other.

In the case of the present embodiment, since the second pump 821 and the transmission member 4 are collectively disposed in the predetermined region, the length of the discharge hose 88c can be shortened. Therefore, the connection structure between the second pump 821 and the transmission member 4 can be made compact. Further, since the discharge hose 88c is short, the maintenance work of the discharge hose 88c can be efficiently performed when the discharge hose 88c is damaged.

In the present embodiment, the first pump 820 and the second pump 821 operate together. However, the first pump 820 and the second pump 821 may operate independently of each other. That is, the first pump 820 may operate in a situation where the first driven part requires the hydraulic oil, and the first pump 820 may stop in a situation where the first driven part does not require the hydraulic oil. The second pump 821 may operate in a situation where the second driven part requires the hydraulic oil, and the second pump 821 may stop in a situation where the second driven part does not require the hydraulic oil.

Alternatively, in a situation where the first driven part does not require the hydraulic oil, the output of the first pump 820 may be set to a predetermined value or less. Further, in a situation where the second driven part does not require the hydraulic oil, the output of the second pump 821 may be set to a predetermined value or less. With such a configuration, power consumption can be suppressed, so that energy saving can be achieved.

In the case of the present embodiment, the first pump 820 and the second pump 821 (hydraulic oil supply device 8) are disposed below the liquid level Si (see FIG. 5) of the hydraulic oil in the tank 51. The liquid level Si of the hydraulic oil in the tank 51 means a liquid level in a state where the hydraulic oil in the tank 51 is supplied to the driven parts (the first driven part and the second driven part) to be minimized. That is, the first pump 820 and the second pump 821 (the hydraulic oil supply device 8) are disposed below the liquid level of the hydraulic oil existing in the tank 51 regardless of the usage state of the hydraulic oil.

With such a configuration, the air in the first pump 820 and the second pump 821 can be efficiently and reliably removed at the time of maintenance. That is, when the air vent holes of the first pump 820 and the second pump 821 are opened to vent the air of the first pump 820 and the second pump 821, the hydraulic oil flows from the tank 51 into the first pump 820 and the second pump 821 on the basis of gravity. As a result, the air in the first pump 820 and the second pump 821 is pushed out from the air vent. As described above, in the case of the present embodiment, since the air in the first pump 820 and the second pump 821 can be reliably removed, it is possible to effectively suppress seizure of the first pump 820 and the second pump 821 caused by the air in the first pump 820 and the second pump 821.

In addition, since the first pump 820 and the second pump 821 are disposed near the tank 51, the operator can easily access the first pump 820 and the second pump 821 at the time of maintenance work including the above-described air bleeding work. As a result, the work efficiency of the maintenance work can be improved.

### <Operations and Effects of Present Embodiment>

According to the present embodiment having the above-described configuration, it is possible to realize the mobile crane 1 that can travel on the basis of the power of the high voltage type battery 70. Specifically, in the case of the present embodiment, as described above, seizure of the first pump 820 and the second pump 821 can be effectively suppressed. In addition, operations and effects exhibited by the mobile crane 1 according to the present embodiment are as described above.

### Second Embodiment

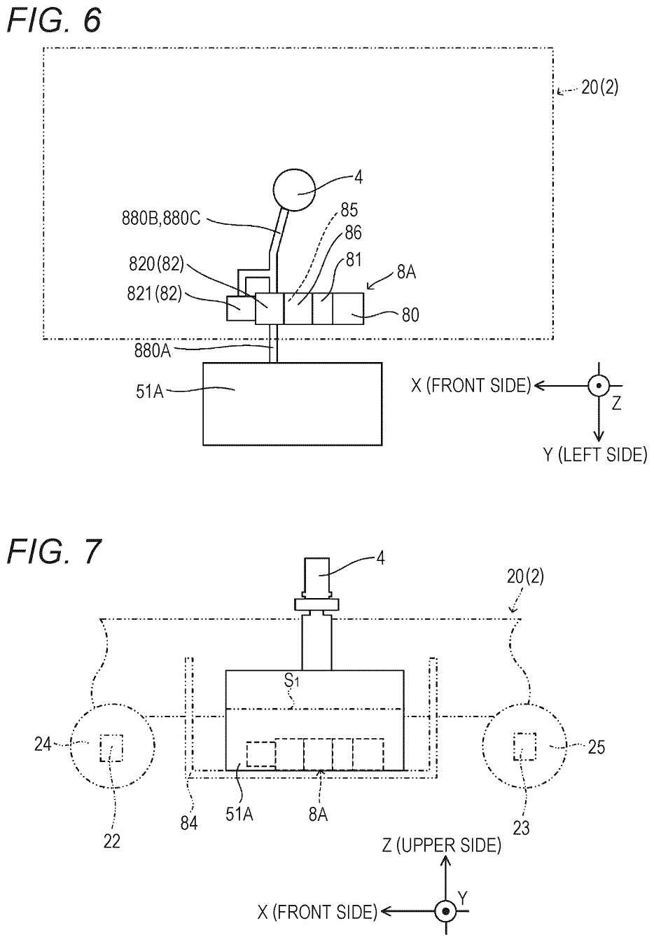

A mobile crane according to the second embodiment of the present invention will be described with reference to FIGS. 6 and 7. The mobile crane of the present embodiment is different from the mobile crane 1 according to the first embodiment in that the configurations of a tank 51A and a hydraulic oil supply device 8A are different from the configurations of the tank 51 and the hydraulic oil supply device 8 of. Hereinafter, configurations of the tank 51A and the hydraulic oil supply device 8A will be described. Description of the configuration similar to that of the mobile crane 1 according to the first embodiment will be omitted as appropriate. For the configuration similar to that of the mobile crane 1 according to the first embodiment, the description of the first embodiment described above may be appropriately cited.

The tank 51A and the hydraulic oil supply device 8A are provided in the lower traveling body 2. Specifically, the tank 51A and the hydraulic oil supply device 8A are disposed in a predetermined region between the front axle 22 and the rear axle 23 and side (left side in the case of the present embodiment) of the frame 20 in the left-right direction.

The tank 51A is a tank for storing hydraulic oil, and has a substantially rectangular parallelepiped box shape. The tank 51A and the hydraulic oil supply device 8A are disposed side by side in the left-right direction in the predetermined region. The tank 51A is disposed outside the hydraulic oil supply device 8A in the width direction of the frame 20 (left side in the case of the present embodiment). As shown in FIG. 6, the tank 51A is disposed side (left side in the case of the present embodiment) of the transmission member 4.

The hydraulic oil supply device 8A is disposed between the tank 51A and the transmission member 4 in the width direction (left-right direction) of the frame 20. The hydraulic oil supply device 8A includes the electric motor 80, the speed reducer 81, and the pump 82 in this order from one side (rear side in the case of the present embodiment) in the axial direction. The electric motor 80, the speed reducer 81, and the pump 82 are coaxially provided. The axial direction of the hydraulic oil supply device 8 is a direction parallel to the center axis of the hydraulic oil supply device 8. In the present embodiment, the axial direction of the hydraulic oil supply device 8 is a direction parallel to the front-rear direction.

The speed reducer 81 and the pump 82 are connected via the coupling 85. The coupling 85 is housed in a cylindrical housing 86. A support (not illustrated) is fixed to the housing 86. The hydraulic oil supply device 8A is fixed to the fixing member 84 fixed to the frame 20 by a support. The configuration of such a hydraulic oil supply device 8A is similar to the configuration of the hydraulic oil supply device 8 of the first embodiment. Therefore, among the configurations of the hydraulic oil supply device 8A, the configuration similar to that of the hydraulic oil supply device 8 of the first embodiment are denoted by the reference numerals similar to those used in the description of the first embodiment.

Each of the first pump 820 and the second pump 821 of the pump 82 is connected to the tank 51A via a discharge hose 880A. The discharge hose 880A extends from the tank 51A toward the pump 82 in parallel to and linearly in the left-right direction. In FIG. 7, the discharge hose 880A is omitted.

In the present embodiment, since the tank 51A and the hydraulic oil supply device 8A (pump 82) are collectively disposed in a predetermined region, the length of the discharge hose 880A can be shortened. Specifically, in the case of the present embodiment, the discharge hose 880A can be configured only by a linear portion. Therefore, the connection structure between the tank 51A and the hydraulic oil supply device 8A (pump 82) can be made compact. Further, since the discharge hose 880A is short, when the discharge hose 880A is damaged, maintenance work of the discharge hose 880A can be efficiently performed.

The first pump 820 and the transmission member 4 are connected via a discharge hose 880B. In the present embodiment, since the first pump 820 and the transmission member 4 are collectively disposed in the predetermined region, the length of the discharge hose 880B can be shortened. In FIG. 7, the discharge hose 880B is omitted.

The second pump 821 and the transmission member 4 are connected via a discharge hose 880C. In FIG. 6, the discharge hose 880B and the discharge hose 880C are illustrated as one discharge hose for the sake of convenience, but the discharge hose 880B and the discharge hose 880C are independent from each other. In the present embodiment, since the second pump 821 and the transmission member 4 are collectively disposed in the predetermined region, the length of the discharge hose 880C can be shortened. In FIG. 7, the discharge hose 880C is omitted.

In the present embodiment, the first pump 820 and the second pump 821 (hydraulic oil supply device 8A) are disposed below the liquid level Si of the hydraulic oil in the tank 51A. Other configurations, operations, and effects of the hydraulic oil supply device 8A are similar to those of the hydraulic oil supply device of the first embodiment described above.

### Third Embodiment

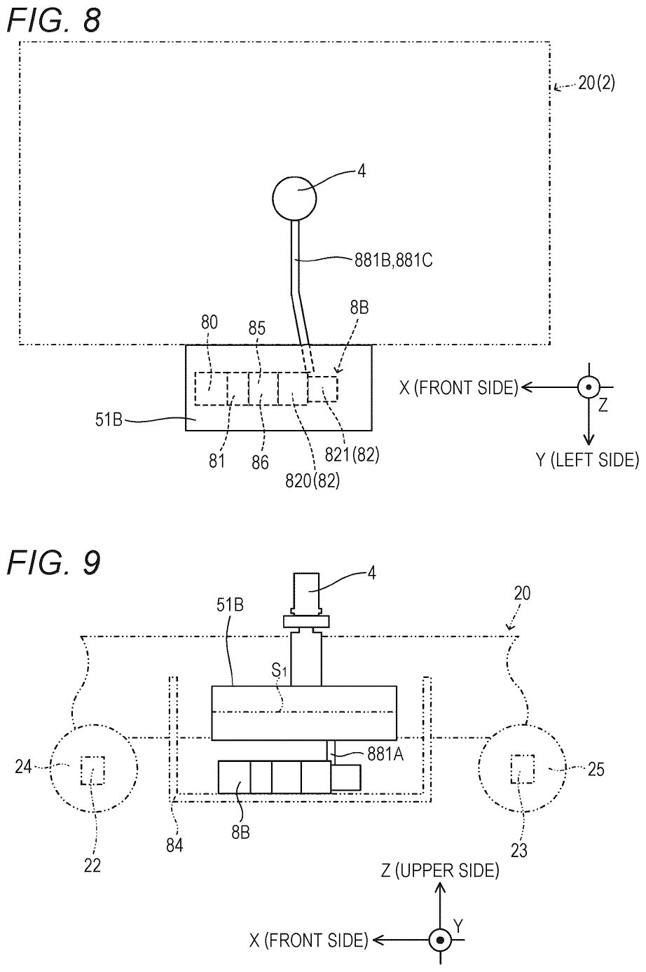

A mobile crane according to the third embodiment of the present invention will be described with reference to FIGS. 8 and 9. The mobile crane of the present embodiment is different from the mobile crane 1 according to the first embodiment in that the configurations of a tank 51B and a hydraulic oil supply device 8B are different from the configurations of the tank 51 and the hydraulic oil supply device 8. Hereinafter, configurations of the tank 51B and the hydraulic oil supply device 8B will be described. Description of the configuration similar to that of the mobile crane 1 according to the first embodiment will be omitted as appropriate. For the configuration similar to that of the mobile crane 1 according to the first embodiment, the description of the first embodiment described above may be appropriately cited.

The tank 51B and the hydraulic oil supply device 8B are provided in the lower traveling body 2. Specifically, the tank 51B and the hydraulic oil supply device 8B are disposed in a predetermined region between the front axle 22 and the rear axle 23 and side (left side in the case of the present embodiment) of the frame 20 in the left-right direction.

The tank 51B is a tank for storing hydraulic oil, and has a substantially rectangular parallelepiped box shape. As shown in FIG. 8, the tank 51B is disposed side (left side in the case of the present embodiment) of the transmission member 4. The tank 51B and the hydraulic oil supply device 8B are disposed side by side in the vertical direction in the predetermined region. The tank 51B is disposed above the hydraulic oil supply device 8B.

The hydraulic oil supply device 8B is disposed side of the transmission member 4 (left side in the case of the present embodiment) and below the tank 51A. The hydraulic oil supply device 8B includes the electric motor 80, the speed reducer 81, and the pump 82 in this order from one side (front side in the case of the present embodiment) in the axial direction. The electric motor 80, the speed reducer 81, and the pump 82 are coaxially provided. The axial direction of the hydraulic oil supply device 8 is a direction parallel to the center axis of the hydraulic oil supply device 8. In the present embodiment, the axial direction of the hydraulic oil supply device 8 is a direction parallel to the front-rear direction.

The speed reducer 81 and the pump 82 are connected via the coupling 85. The coupling 85 is housed in a cylindrical housing 86. A support (not illustrated) is fixed to the housing 86. The hydraulic oil supply device 8B is fixed to a fixing member 84 fixed to the frame 20 by a support. Other configurations of the hydraulic oil supply device 8B are similar to those of the hydraulic oil supply device 8 of the first embodiment. Therefore, among the configurations of the hydraulic oil supply device 8B, the configuration similar to that of the hydraulic oil supply device 8 of the first embodiment are denoted by the reference numerals similar to those used in the description of the first embodiment.

Each of the first pump 820 and the second pump 821 of the pump 82 is connected to the tank 51B via a discharge hose 881A. The discharge hose 881A extends from the tank 51B toward the pump 82 in parallel to and linearly in the vertical direction. In FIG. 9, the discharge hose 881A is omitted.

In the present embodiment, since the tank 51B and the hydraulic oil supply device 8B (pump 82) are collectively disposed in a predetermined region, the length of the discharge hose 881A can be shortened. Specifically, in the case of the present embodiment, the discharge hose 881A can be configured only by a linear portion. Therefore, the connection structure between the tank 51B and the hydraulic oil supply device 8B (pump 82) can be made compact. Further, since the discharge hose 881A is short, when the discharge hose 881A is damaged, maintenance work of the discharge hose 881A can be efficiently performed.

The first pump 820 and the transmission member 4 are connected via a discharge hose 881B. In the present embodiment, since the first pump 820 and the transmission member 4 are collectively disposed in the predetermined region, the length of the discharge hose 881B can be shortened. In FIG. 9, the discharge hose 881B is omitted.

The second pump 821 and the transmission member 4 are connected via a discharge hose 881C. In FIG. 9, the discharge hose 881B and the discharge hose 881C are illustrated as one discharge hose for the sake of convenience, but the discharge hose 881B and the discharge hose 881C are independent from each other. In the present embodiment, since the second pump 821 and the transmission member 4 are collectively disposed in the predetermined region, the length of the discharge hose 881C can be shortened. In FIG. 9, the discharge hose 881C is omitted.

In the present embodiment, the first pump 820 and the second pump 821 (hydraulic oil supply device 8B) are disposed below the liquid level Si of the hydraulic oil in the tank 51B. In the case of the present embodiment, since the first pump 820 and the second pump 821 (hydraulic oil supply device 8B) are disposed below the tank 51B, the first pump 820 and the second pump 821 (hydraulic oil supply device 8B) can be reliably disposed below the liquid level Si of the hydraulic oil in the tank 51B. Other configurations, operations, and effects of the hydraulic oil supply device 8B are similar to those of the hydraulic oil supply device of the first embodiment described above.

### Fourth Embodiment

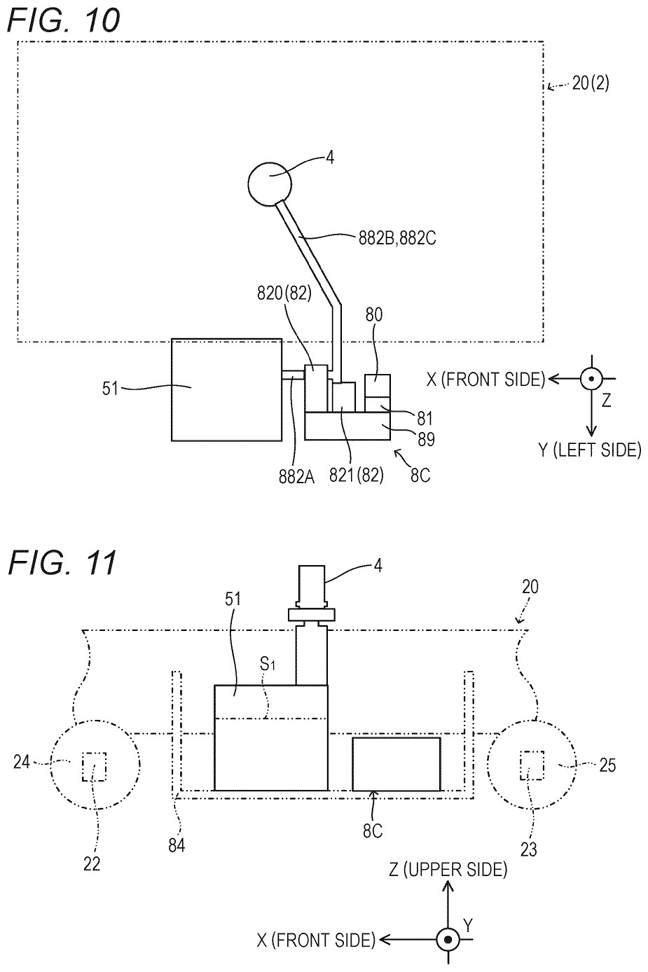

A mobile crane according to the fourth embodiment of the present invention will be described with reference to FIGS. 10 and 11. The mobile crane of the present embodiment is different from the mobile crane 1 according to the first embodiment in that the configuration of a hydraulic oil supply device 8C is different from the configuration of the hydraulic oil supply device 8. Hereinafter, the configuration of the hydraulic oil supply device 8C will be described. Description of the configuration similar to that of the mobile crane 1 according to the first embodiment will be omitted as appropriate. For the configuration similar to that of the mobile crane 1 according to the first embodiment, the description of the first embodiment described above may be appropriately cited.

The tank 51 and the hydraulic oil supply device 8C are provided in the lower traveling body 2. Specifically, the tank 51 and the hydraulic oil supply device 8C are disposed in a predetermined region between the front axle 22 and the rear axle 23 and side (left side in the case of the present embodiment) of the frame 20 in the left-right direction.

As in the first embodiment, the tank 51 is a tank for storing hydraulic oil, and has a substantially rectangular parallelepiped box shape. The tank 51 and the hydraulic oil supply device 8B are disposed side by side in the front-rear direction in the predetermined region. The tank 51 is disposed in front of the hydraulic oil supply device 8C. As shown in FIG. 11, the tank 51 is disposed side (left side in the case of the present embodiment) of the transmission member 4.

The hydraulic oil supply device 8C is disposed side (left side in the case of the present embodiment) of the transmission member 4 and behind the tank 51. The hydraulic oil supply device 8C includes the electric motor 80, the speed reducer 81, and the pump 82. The electric motor 80 and the speed reducer 81 are coaxially provided. The speed reducer 81 is provided on one side (left side in the case of the present embodiment) in the axial direction of the electric motor 80. In the case of the present embodiment, the axial direction of the electric motor 80 is a direction parallel to the left-right direction.

The speed reducer 81 is connected to a transmission device 89 for transmitting rotation to the pump 82. The transmission device 89 includes, for example, a plurality of gears meshed with each other and a housing that accommodates the respective gears. The transmission device 89 transmits the rotation of the electric motor 80 received from the speed reducer 81 to the pump 82 (the first pump 820 and the second pump 821).

The pump 82 includes the first pump 820 and the second pump 821. The first pump 820 and the second pump 821 are disposed in parallel. That is, the center axis of the first pump 820 and the center axis of the second pump 821 are parallel to each other. The center axes of the first pump 820 and the second pump 821 are parallel to the left-right direction. Therefore, the center axes of the first pump 820 and the second pump 821 are parallel to the center axes of the electric motor 80 and the speed reducer 81.

The first pump 820 and the second pump 821 are connected to the electric motor 80 via the transmission device 89 and the speed reducer 81. That is, the electric motor 80, the speed reducer 81, the pump 82 (the first pump 820 and the second pump 821), and the speed reducer 81 are integrated in a separable state. In other words, the electric motor 80 and the pump 82 (the first pump 820 and the second pump 821) are connected in parallel.

Each of the first pump 820 and the second pump 821 is connected to the tank 51 via a discharge hose 882A. The discharge hose 882A extends from the tank 51 toward the pump 82 in parallel to and linearly in the front-rear direction. The discharge hose 882A may have a configuration similar to that of the discharge hose 88a (see FIG. 4) of the first embodiment. In FIG. 11, the discharge hose 882A is omitted. In the present embodiment, since the tank 51 and the hydraulic oil supply device 8C (pump 82) are collectively disposed in a predetermined region, the length of the discharge hose 882A can be shortened.

The first pump 820 and the transmission member 4 are connected via a discharge hose 882B. In the present embodiment, since the first pump 820 and the transmission member 4 are collectively disposed in the predetermined region, the length of the discharge hose 882B can be shortened. In FIG. 11, the discharge hose 882B is omitted.

The second pump 821 and the transmission member 4 are connected via a discharge hose 882C. In FIG. 10, the discharge hose 882B and the discharge hose 882C are illustrated as one discharge hose for the sake of convenience, but the discharge hose 882B and the discharge hose 882C are independent from each other. In the present embodiment, since the second pump 821 and the transmission member 4 are collectively disposed in the predetermined region, the length of the discharge hose 882C can be shortened. In FIG. 11, the discharge hose 882C is omitted.

In the present embodiment, the first pump 820 and the second pump 821 (hydraulic oil supply device 8C) are disposed below the liquid level Si of the hydraulic oil in the tank 51.

As described above, in the present embodiment, the electric motor 80 and the pump 82 are provided in parallel. Therefore, the length of the hydraulic oil supply device 8C in the direction of the center axis of the electric motor 80 can be shortened. Other configurations, operations, and effects of the hydraulic oil supply device 8B are similar to those of the hydraulic oil supply device of the first embodiment described above.

### Fifth Embodiment

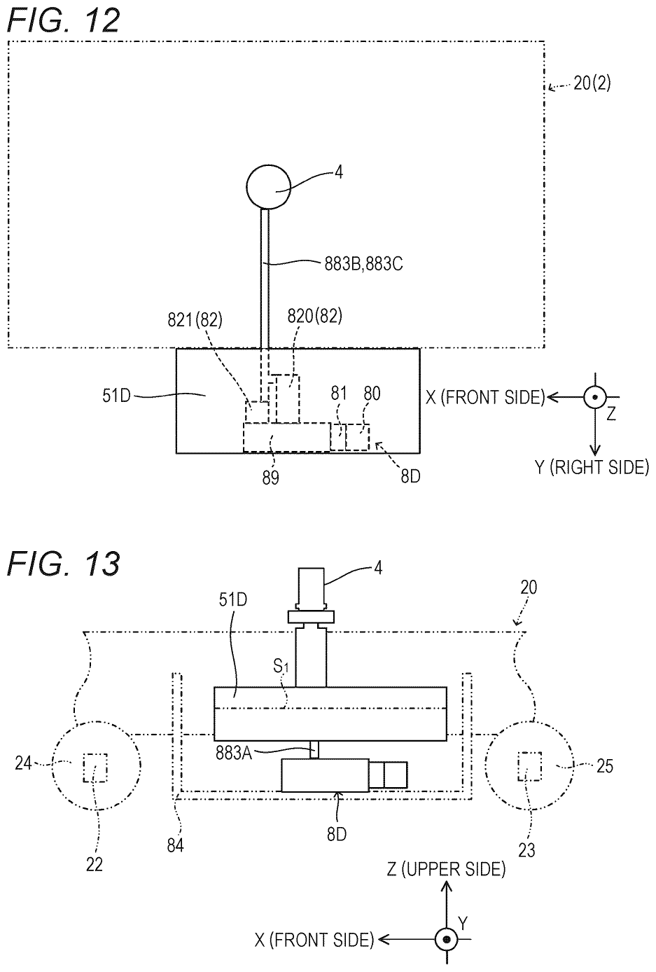

A mobile crane according to the fifth embodiment of the present invention will be described with reference to FIGS. 12 and 13. The mobile crane of the present embodiment is different from the mobile crane 1 according to the first embodiment in that the configurations of a tank 51D and a hydraulic oil supply device 8D are different from the configurations of the tank 51 and the hydraulic oil supply device 8. Hereinafter, configurations of the tank 51D and the hydraulic oil supply device 8D will be described. Description of the configuration similar to that of the mobile crane 1 according to the first embodiment will be omitted as appropriate. For the configuration similar to that of the mobile crane 1 according to the first embodiment, the description of the first embodiment described above may be appropriately cited.

The tank 51D and the hydraulic oil supply device 8D are provided in the lower traveling body 2. Specifically, the tank 51D and the hydraulic oil supply device 8D are disposed in a predetermined region between the front axle 22 and the rear axle 23 and side (left side in the case of the present embodiment) of the frame 20 in the left-right direction.

The tank 51D is a tank for storing hydraulic oil, and has a substantially rectangular parallelepiped box shape. The tank 51D and the hydraulic oil supply device 8D are disposed side by side in the vertical direction in the predetermined region. The tank 51D is disposed above the hydraulic oil supply device 8D. As shown in FIG. 12, the tank 51D is disposed side (left side in the case of the present embodiment) of the transmission member 4.

The hydraulic oil supply device 8D is disposed side of the transmission member 4 (left side in the case of the present embodiment) and below the tank 51D. The hydraulic oil supply device 8D includes the electric motor 80, the speed reducer 81, and the pump 82. The electric motor 80 and the speed reducer 81 are coaxially provided. The speed reducer 81 is provided on one side (front side in the case of the present embodiment) in the axial direction of the electric motor 80. In the case of the present embodiment, the axial direction of the electric motor 80 is a direction parallel to the front-rear direction.

The speed reducer 81 is connected to a transmission device 89 for transmitting rotation to the pump 82. The transmission device 89 is disposed in front of the speed reducer 81. The transmission device 89 includes, for example, a plurality of gears meshed with each other and a housing that accommodates the respective gears. The transmission device 89 transmits the rotation of the electric motor 80 received from the speed reducer 81 to the pump 82 (the first pump 820 and the second pump 821).

The pump 82 includes the first pump 820 and the second pump 821. The first pump 820 and the second pump 821 are disposed in parallel. That is, the center axis of the first pump 820 and the center axis of the second pump 821 are parallel to each other. The center axes of the first pump 820 and the second pump 821 are parallel to the left-right direction. Therefore, the center axes of the first pump 820 and the second pump 821 are orthogonal to the center axes of the electric motor 80 and the speed reducer 81.

The first pump 820 and the second pump 821 are connected to the speed reducer 81 via the transmission device 89. That is, the electric motor 80, the speed reducer 81, the pump 82 (the first pump 820 and the second pump 821), and the speed reducer 81 are integrated in a separable state.

Each of the first pump 820 and the second pump 821 is connected to the tank 51D via a discharge hose 883A. The discharge hose 883A extends from the tank 51D toward the pump 82 in parallel to and linearly in the vertical direction. In the present embodiment, since the tank 51D and the hydraulic oil supply device 8D (pump 82) are collectively disposed in a predetermined region, the length of the discharge hose 883A can be shortened.

The first pump 820 and the transmission member 4 are connected via a discharge hose 883B. In the present embodiment, since the first pump 820 and the transmission member 4 are collectively disposed in the predetermined region, the length of the discharge hose 883B can be shortened. In FIG. 13, the discharge hose 883B is omitted.

The second pump 821 and the transmission member 4 are connected via a discharge hose 883C. In FIG. 12, the discharge hose 883B and the discharge hose 883C are illustrated as one discharge hose for the sake of convenience, but the discharge hose 883B and the discharge hose 883C are independent from each other. In the present embodiment, since the second pump 821 and the transmission member 4 are collectively disposed in the predetermined region, the length of the discharge hose 883C can be shortened. In FIG. 13, the discharge hose 883C is omitted.

In the present embodiment, the first pump 820 and the second pump 821 (hydraulic oil supply device 8D) are disposed below the liquid level Si of the hydraulic oil in the tank 51D.

As described above, in the present embodiment, the electric motor 80 and the pump 82 are provided in parallel. Therefore, the length of the hydraulic oil supply device 8D in the direction of the center axis of the electric motor 80 can be shortened. Other configurations, operations, and effects of the hydraulic oil supply device 8B are similar to those of the hydraulic oil supply device of the first embodiment described above.

### Sixth Embodiment

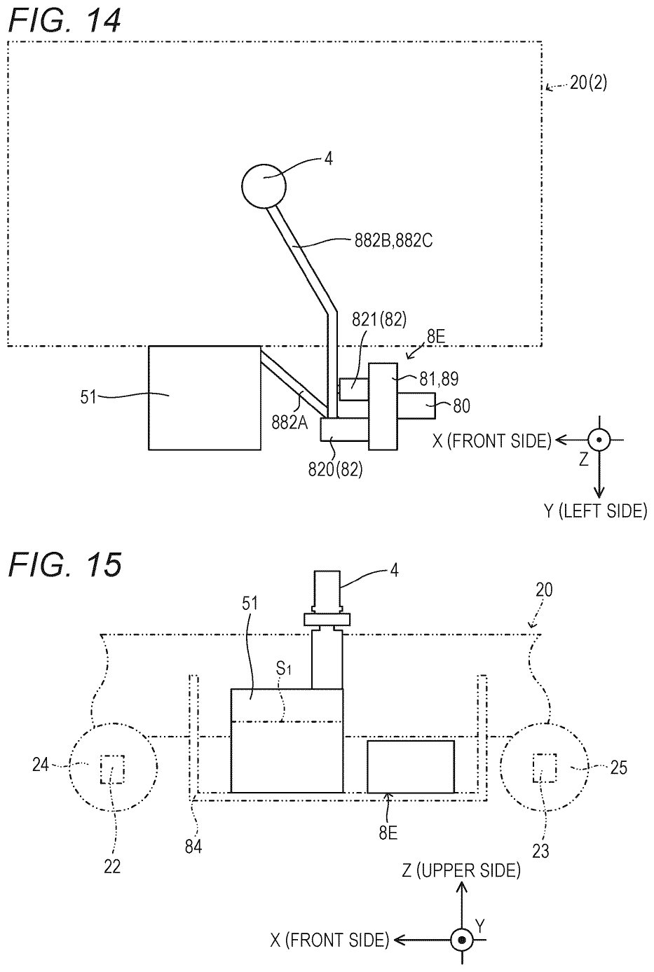

A mobile crane according to the sixth embodiment of the present invention will be described with reference to FIGS. 14 and 15. The mobile crane of the present embodiment is different from the mobile crane 1 according to the first embodiment in that the configuration of a hydraulic oil supply device 8E is different from the configuration of the hydraulic oil supply device 8. Hereinafter, the configuration of the hydraulic oil supply device 8E will be described. Description of the configuration similar to that of the mobile crane 1 according to the first embodiment will be omitted as appropriate. For the configuration similar to that of the mobile crane 1 according to the first embodiment, the description of the first embodiment described above may be appropriately cited.

The tank 51 and the hydraulic oil supply device 8E are provided in the lower traveling body 2. Specifically, the tank 51 and the hydraulic oil supply device 8E are disposed in a predetermined region between the front axle 22 and the rear axle 23 and side (left side in the case of the present embodiment) of the frame 20 in the left-right direction.

As in the first embodiment, the tank 51 is a tank for storing hydraulic oil, and has a substantially rectangular parallelepiped box shape. The tank 51 and the hydraulic oil supply device 8E are disposed side by side in the front-rear direction in the predetermined region. The tank 51 is disposed in front of the hydraulic oil supply device 8E. As shown in FIG. 14, the tank 51 is disposed side (left side in the case of the present embodiment) of the transmission member 4.

The hydraulic oil supply device 8E is disposed side (left side in the case of the present embodiment) of the transmission member 4 and behind the tank 51. The hydraulic oil supply device 8E includes the electric motor 80, the speed reducer 81, and the pump 82. In the present embodiment, the speed reducer 81 is incorporated in the transmission device 89.

The speed reducer 81 and the transmission device 89 are provided on one side (front side in the case of the present embodiment) in the axial direction of the electric motor 80. In the case of the present embodiment, the axial direction of the electric motor 80 is a direction parallel to the front-rear direction.

The speed reducer 81 is connected to a transmission device 89 for transmitting rotation to the pump 82. The transmission device 89 includes, for example, a plurality of gears meshed with each other and a housing that accommodates the respective gears. The transmission device 89 transmits the rotation of the electric motor 80 received from the speed reducer 81 to the pump 82 (the first pump 820 and the second pump 821).

The pump 82 includes the first pump 820 and the second pump 821. The first pump 820 and the second pump 821 are disposed in parallel. That is, the center axis of the first pump 820 and the center axis of the second pump 821 are parallel to each other. The center axes of the first pump 820 and the second pump 821 are parallel to the front-rear direction. Therefore, the center axes of the first pump 820 and the second pump 821 are parallel to the center axis of the electric motor 80.

The electric motor 80 is provided opposite the pump 82 (the first pump 820 and the second pump 821) in the front-rear direction with the transmission device 89 and the speed reducer 81 as the center. Specifically, the pump 82 (the first pump 820 and the second pump 821) is provided in front of the transmission device 89 and the speed reducer 81. The electric motor 80 is provided behind the transmission device 89 and the speed reducer 81.

The first pump 820 and the second pump 821 are connected to the electric motor 80 via the transmission device 89 and the speed reducer 81. That is, the electric motor 80, the speed reducer 81, the pump 82 (the first pump 820 and the second pump 821), and the speed reducer 81 are integrated in a separable state. In other words, the electric motor 80 and the pump 82 (the first pump 820 and the second pump 821) are connected in parallel.

Each of the first pump 820 and the second pump 821 is connected to the tank 51 via a discharge hose 882A. The discharge hose 882A extends from the tank 51 toward the pump 82 in an inclined state and linearly in the front-rear direction. The configuration of the discharge hose 882A may be similar to that of the discharge hose 88a (see FIG. 4) of the first embodiment.

In FIG. 15, the discharge hose 882A is omitted. In the present embodiment, since the tank 51 and the hydraulic oil supply device 8C (pump 82) are collectively disposed in a predetermined region, the length of the discharge hose 882A can be shortened.

The first pump 820 and the transmission member 4 are connected via a discharge hose 882B. In the present embodiment, since the first pump 820 and the transmission member 4 are collectively disposed in the predetermined region, the length of the discharge hose 882B can be shortened. In FIG. 15, the discharge hose 882B is omitted.

The second pump 821 and the transmission member 4 are connected via a discharge hose 882C. In FIG. 14, the discharge hose 882B and the discharge hose 882C are illustrated as one discharge hose for the sake of convenience, but the discharge hose 882B and the discharge hose 882C are independent from each other. In the present embodiment, since the second pump 821 and the transmission member 4 are collectively disposed in the predetermined region, the length of the discharge hose 882C can be shortened. In FIG. 15, the discharge hose 882C is omitted.

In the present embodiment, the first pump 820 and the second pump 821 (hydraulic oil supply device 8C) are disposed below the liquid level Si of the hydraulic oil in the tank 51.

In the case of the present embodiment, the electric motor 80, the first pump 820, and the second pump 821 are disposed in a state where the center axes thereof are parallel to the front-rear direction. However, the electric motor 80, the first pump 820, and the second pump 821 may be disposed in a state where the respective center axes are inclined in the front-rear direction.

As described above, in the present embodiment, the first pump 820 and the second pump 821 are provided in parallel. Therefore, the length of the hydraulic oil supply device 8E in the direction of the center axis of the electric motor 80 can be shortened. Other configurations, operations, and effects of the hydraulic oil supply device 8E are similar to those of the hydraulic oil supply device of the first embodiment described above.

This application is based upon and claims the benefit of priority from Japanese Patent Application No. 2022-102122, filed on Jun. 24, 2022, the entire contents of which are incorporated herein by reference.

### Industrial Applicability

The crane according to the present invention is not limited to a rough terrain crane and may be various mobile cranes such as an all-terrain crane, a truck crane, and a loading truck crane (also referred to as a cargo crane).

### REFERENCE SIGNS LIST

1 mobile crane
2 lower traveling body
20 frame
20a upper plate portion
20b lower plate portion
20c right plate portion
20d left plate portion
20e front plate portion
20f rear plate portion
200 transmission member arrangement space
201 battery housing space
202 front outrigger support
203 rear outrigger support
21 body
22 front axle
23 rear axle
24 front tire
25 rear tire
26 outrigger
26a front outrigger
26b rear outrigger
3 upper swing body
31 turning table
32 telescopic boom
33 cab
34 derricking cylinder
35 telescopic cylinder
36 wire rope
37 hook
38 winch
4 transmission member
5 hydraulic system
51, 51A, 51B, 51D tank
510 outlet-port
52 lower hydraulic device
53 upper hydraulic device
530 upper first hydraulic device
531 upper second hydraulic device
6 low voltage type system
60 lower controller
61 upper controller
63 low voltage type battery
7 high voltage type system
70 high voltage type battery
701a, 701b first battery
73 traveling motor
74 upper electric device
8, 8A, 8B, 8C, 8D, 8E hydraulic oil supply device
80 electric motor
81 speed reducer
82, pump
82A pump
820 first pump
821 second pump
822 inlet-port
83 inverter
84 fixing member
85 coupling
86 housing
87 support
88a, 88b, 88c discharge hose
880A, 880B, 880C discharge hose
881A, 881B, 881C discharge hose
882A, 882B, 882C discharge hose
883A, 883B, 883C discharge hose
89 transmission device

1. A crane comprising:
a traveling vehicle body that travels on a basis of power supplied from a power source;
a hydraulic oil tank provided in the traveling vehicle body; and
a hydraulic oil supply device including a motor driven by the power source and a pump part driven by the motor and supplying hydraulic oil to a driven part, the hydraulic oil being supplied from the hydraulic oil tank, wherein
the pump part is disposed below a liquid level of hydraulic oil in the hydraulic oil tank.

2. The crane according to claim 1, wherein
the driven part includes a plurality of the driven parts, and wherein
the pump part includes a plurality of pumps corresponding to the plurality of driven parts and connected in series or in parallel.

3. The crane according to claim 1, wherein
the hydraulic oil supply device and the hydraulic oil tank are disposed beside a main frame of the traveling vehicle body and between a pair of front and rear axles, and wherein
the hydraulic oil supply device is disposed side of or below the hydraulic oil tank.

4. The crane according to claim 3, further comprising:
a transmission member that connects a swing body provided in an upper portion of the traveling vehicle body and the hydraulic oil supply device, wherein
the pump part is disposed between the hydraulic oil tank and the transmission member.

5. The crane according to claim 1, wherein the motor and the pump part are connected in series.

6. The crane according to claim 1, wherein the motor and the pump part are connected in parallel.

7. The crane according to claim 1, wherein the motor and the pump part are connected to each other in a state in which center axes of the motor and the pump part are orthogonal to each other.

8. The crane according to claim 1, wherein the motor and the pump part are disposed in a state in which center axes of the motor and the pump part are parallel to each other.
